(19) United States
(12) Patent Application Publication
(10) Pub. No.: US 2002/0116233 A1
(43) Pub. Date: Aug. 22, 2002

(54) Facility administration apparatus and method

(75) Inventor: Shigehiro Kuge, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 09/846,276

(22) Filed: May 2, 2001

(30) Foreign Application Priority Data
Dec. 18, 2000 (JP) 2000-383174(P)

(51) Int. Cl. G06F 17/60

(52) U.S. Cl. 705/5; 705/7

(57) ABSTRACT

A facility administration apparatus determines the current position of the facility user from the identifier of a relay station having successfully made the transmission to the mobile device and guides the user to follow the shortest route to a facility that the user has made a reservation of. Each facility is provided with a facility terminal via which a payment to be rendered by the facility user for each facility that the user has used is recorded for the identifier of the mobile device of the facility user to allow the user to collectively pay his/her accounts via an exit terminal. The present facility administration apparatus and method allows a facility user in an area having facilities collected therein to use his/her reserved facility without missing his/her reservation time and also pay the fee for each facility in a simplified manner.

### BACKGROUND OF THE INVENTION

1. Field of the Invention

The present invention relates generally to facility administration apparatus and methods and particularly to facility administration apparatus and methods arranged in an area having multiple facilities collected therein, capable of communicating with a mobile device lent to a facility user via a plurality of relay stations each having a transceiver, and organizing a reservation of each facility as reservation information in response to a request transmitted from the mobile device for a reservation of each facility.

2. Description of the Background Art

Gigantic amusement parks having amusement facilities therein conventionally do not have a system allowing a visitor or facility user to make a reservation of an amusement facility before the visitor uses the facility, and if the visitor desires to use a very popular amusement facility the visitor must wait for his/her term standing in a queue.

While the visitor is waiting for his/her turn to use the popular amusement facility the visitor cannot use the other amusement facilities. Thus the user cannot use amusement facilities conveniently.

It is of greater benefit to those running amusement parks that visitors use different amusement facilities, shops and the like, rather than exclusively use a specific amusement facility, as such would increase sales.

Japanese Patent Laying-Open No. 8-106497 suggests such an invention as described above wherein in an amusement park a visitor no longer needs to wait his/her term to use an amusement facility.

However, if in an amusement park a visitor has successfully made a reservation of an amusement facility, the visitor must arrive at the amusement facility no later than his/her reservation time. If the amusement park is a gigantic amusement park, it would have a large number of amusement facilities and the visitor may fail to arrive at the amusement facility no later than the reservation time, insufficiently understanding the route to the amusement facility that the visitor has made a reservation of. If the visitor has failed to arrive at the amusement facility no later than the reservation time the visitor could not use the amusement facility conveniently.

Further, it is cumbersome for a visitor in an amusement park to pay a fee for each amusement facility that the visitor uses or pay at each shop a price for an item that the visitor has purchased. This also prevents the visitor from using amusement facilities conveniently.

### SUMMARY OF THE INVENTION

The present invention contemplates a facility administration apparatus and methods allowing a facility user to use his/her reserved amusement facility without failing to arrive at the facility no later than his/her reservation time for the facility, and also eliminating the necessity of the facility user rendering payment for each amusement facility or shop to allow the facility user to use the amusement facility conveniently.

The present invention provides a facility administration apparatus arranged in an area having a plurality of facilities collected therein, capable of communicating with a mobile device lent to a facility user via a plurality of relay stations each having a transceiver, and organizing a reservation of each facility as reservation information in response to a request transmitted from the mobile device for a reservation of each facility, the facility administration apparatus including: a reservation information master file storing the reservation information for each facility an identifier of the mobile device carried by the facility user having made a reservation, information of a facility reserved by the facility user, and a time at which the facility user desires to use the facility; a block referring to the time in the reservation information master file to transmit via the relay station to the mobile device of the facility user a predetermined temporal period before the time a notification indicating that the time is approaching; a block receiving an identifier of the relay station having transmitted the notification to the mobile device, and determining from the identifier of the relay station a position of the facility user carrying the mobile device with the user; a shortest-route master file previously storing a shortest route from each subarea of the area to each facility; a block determining a shortest route based on the position determined of the facility user, the information stored in the facility reservation master file indicating the facility reserved by the facility user, and the shortest-route master file; and a block transmitting information of the shortest route.

Thus the facility user can arrive at his/her reserved facility no later than the time at which the user desires to use the facility.

Preferably the block reserving and determining determines as a subarea having the facility user located therein a range surrounded by a plurality of the relay stations having transmitted the notification to the mobile device.

Thus the user's position can be determined.

The present invention provides a facility administration arranged in an area having a plurality of facilities collected therein, and connectable via a network to a facility terminal arranged at each facility connectable to a mobile device, including: an identifier master file storing an identifier of a mobile device available; a block comparing an identifier of a mobile device transmitted from the mobile device via the facility terminal with the identifier of the mobile device stored in the identifier master file; a block receiving account information from the facility terminal if the identifier of the mobile device transmitted from the mobile device matches the identifier of the mobile device stored in the identifier master file; and an account information master file storing the account information for the identifier of each the mobile device.

Thus the facility administration apparatus can store account information for each facility user and as a result the facility user no longer needs to cumbersomely render payment for each facility and can thus use the facility conveniently.

Preferably, the identifier master file further stores an identifier of the facility user carrying the mobile device with the user, the block comparing compares the identifier of the mobile device and the identifier of the facility user together transmitted from the mobile device via the facility terminal with the identifier of the mobile device and the identifier of the facility user together stored in the identifier master file, and if the identifier of the mobile device and the identifier of the facility user together transmitted from the mobile device match the identifier of the mobile device and the identifier of the facility user together stored in the identifier master file then the facility administration apparatus receives account information transmitted from the facility terminal.

Thus, if the facility user has lost his/her mobile device and another person has acquired the mobile device, the person is required to input the identifier of the facility user and that person thus cannot use the mobile device.

Still preferably, the identifier master file imposes a period of validity on the identifier of the facility user carrying the mobile device with the user.

Since facility user is assigned an identifier having a limited period of validity imposed thereon, if another person having acquired the user's mobile device has also acquired the user's identifier the person can only use the mobile device of the facility user for the limited period of validity.

In the present invention, a facility user in an amusement park can use the mobile device to make a reservation of each facility and the user carrying the mobile device with him/her can be positionally determined via the relay stations. As such, the facility user can be informed of the shortest route to be followed from the user's current position to a facility reserved by the user. Thus the facility user can use the reserved amusement facility, arriving there no later than his/her reservation time for the facility.

Furthermore, the facility administration apparatus can create an account information table for each facility user. Thus the facility user can use amusement facilities conveniently, no longer required to cumbersomely render payment for each amusement facility or shop.

The foregoing and other objects, features, aspects and advantages of the present invention will become more apparent from the following detailed description of the present invention when taken in conjunction with the accompanying drawings.

### BRIEF DESCRIPTION OF THE DRAWINGS

In the drawings:

FIG. 1 generally shows a configuration of a facility administration system in an embodiment of the present invention;

FIG. 2A is a block diagram showing a configuration of a facility administration apparatus and FIG. 2B is a block diagram showing a configuration of a relay station;

FIGS. 3A-3D are block diagrams showing first to fourth configurations of a mobile device;

FIGS. 4A-4D show appearances of a mobile device having the configurations shown in FIGS. 3A-3D, respectively;

FIG. 5 is a flow chart representing an operation of a function determining a facility user in an embodiment of the present invention.

FIG. 6 is a flow chart representing an operation of a reservation function when a direct-contact mobile device in an embodiment of the present invention is used;

FIG. 7 is a flow chart representing an operation of a guide function in an embodiment of the present invention;

FIG. 8A schematic illustrates a method of determining the position of a facility user in an amusement park carrying the mobile device with him/her, and FIG. 8B schematically illustrates subareas in the amusement park that are surrounded by relay stations;

FIG. 9 is a flow chart representing an operation of one of a count functions in an embodiment of the present invention when a visitor has purchased an item at a shop, enjoys services at a restaurant or uses an attraction facility; and

FIG. 10 is a flow chart representing an operation of one of account functions in an embodiment of the present invention that is provided at an exit gate.

### DESCRIPTION OF THE PREFERRED EMBODIMENTS

Hereinafter the embodiments of the present invention will be described in detail with reference to the drawings. In the figures, like components are leveled like reference characters and will thus not be described repeatedly.

1. Configuration of Facility Administration System

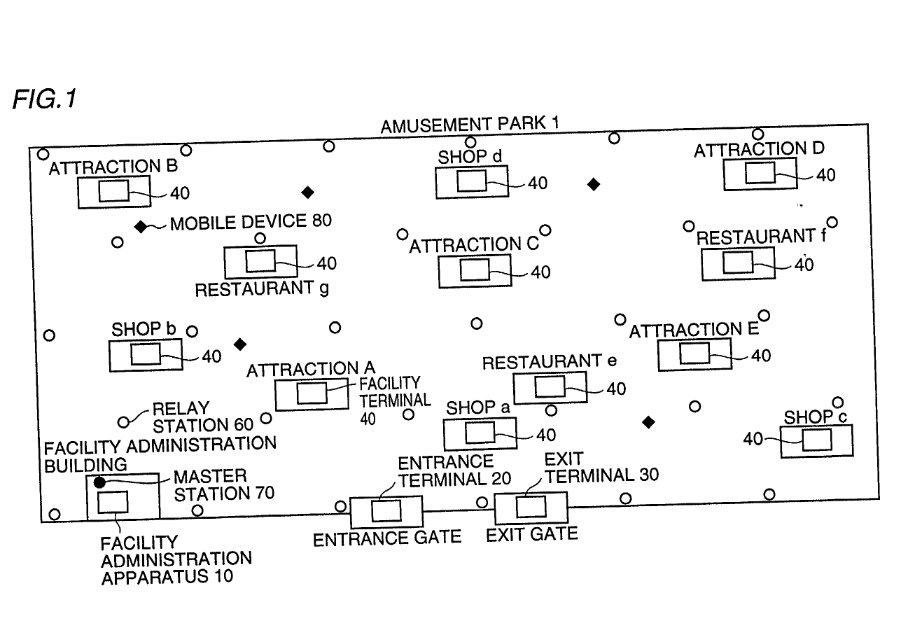

FIG. 1 generally shows a configuration of a facility administration system in an embodiment of the present invention.

As shown in FIG. 1, an amusement park 1 includes attractions A-E corresponding to amusement facilities, shops a-d, restaurants e-g, an entrance gate, an exit gate, and an administration building.

The administration building is provided with a facility administration apparatus 10, and the entrance and exit gates are provided with an entrance terminal 20 and an exit terminal 30, respectively. Furthermore, attractions A-E, shops a-d and restaurants e-g are each provided with a facility terminal 40. Facility administration apparatus 10, entrance terminal 20, exit terminal 30 and facility terminal 40 are interconnected by an internal, local area network (not shown).

In the amusement park a visitor borrows a mobile device 80. The facility administration building includes a master station 70 connected to facility administration apparatus 10. Master station 70 transmits information which is in turn received by mobile device 80 via a plurality of relay stations 60 provided in amusement park 1. Mobile device 80 transmits information which is in turn transmitted by relay station 60 and master station 70 to facility administration apparatus 10.

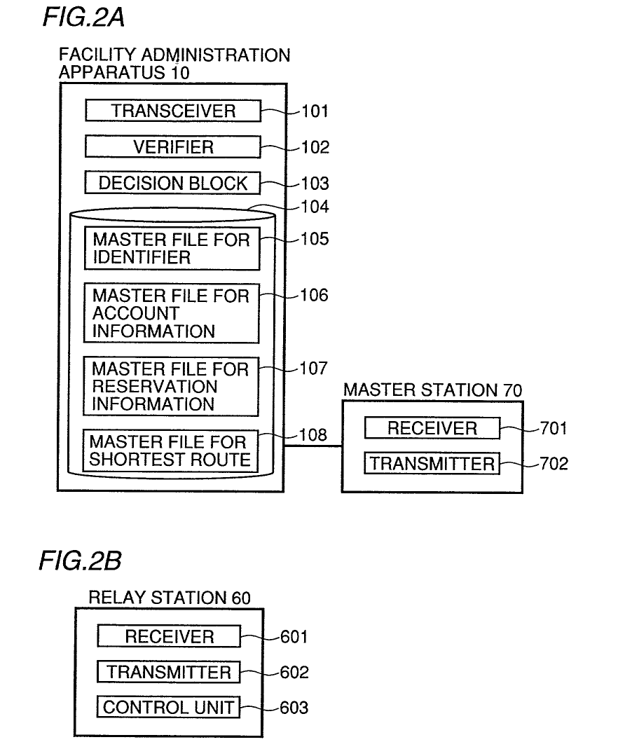

FIG. 2A is a block diagram showing a configuration of a facility administration apparatus.

As shown in FIG. 2A, facility administration apparatus 10 includes a transceiver 101, a verifier 102 verifying an identifier of mobile device 80 and an identifier of a facility user, a decision block 103 and a hard disk 104.

decision block 103 operates to: determines whether a visitor can make a reservation of a facility; notify the visitor of his/her reservation time a predetermined period of time before the reservation time; and determine a shortest route from the current position of the visitor to the attraction that the visitor has made a reservation of.

Hard disk 104 includes a master file 105 provided to register a mobile device ID corresponding to an identifier of mobile device 80 and a password determined by a visitor to serve as an identifier of the visitor, a master file 106 storing information of visitors' accounts in amusement park 1, a master file 107 storing information managing reservations of each attraction in amusement park 1, and master file 108 storing information of shortest routes to guide a visitor to his/her reserved attraction in a shortest route.

Master station 70 includes a receiver 701 receiving a signal from relay station 60 and a transmitter 702 receiving information from facility administration apparatus 10 and transmitting the received information to each relay station 60. Facility administration apparatus 10 may internally have master station 70.

FIG. 2B is a block diagram showing a configuration of the relay station.

As shown in FIG. 2B, relay station 60 includes a receiver 601 receiving a signal from mobile device 80 or master station 70, a transmitter 602 transmitting a signal to mobile device 80 or master station 70, and a controller 603 making a decision as to whether a signal has been successfully transmitted to mobile device 80 and, if so, making a decision to transmit the relay station's identifier to master station 70.

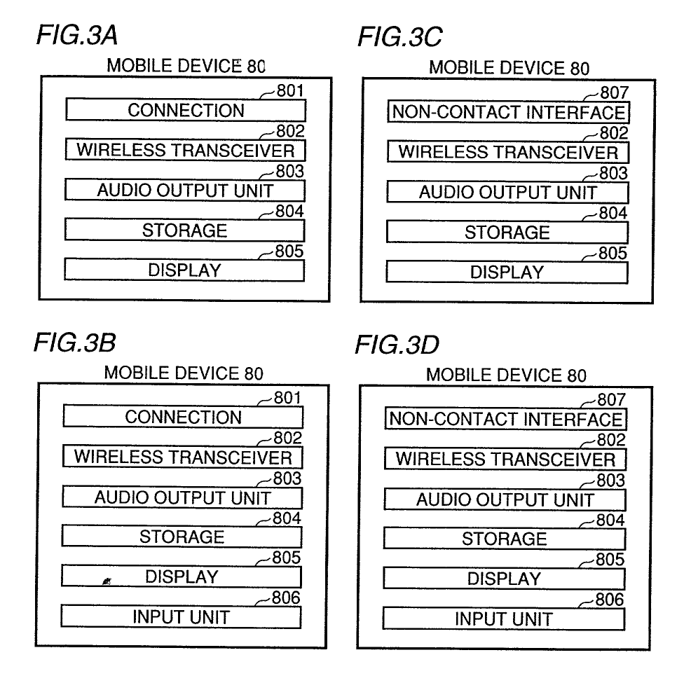

FIG. 3A is a block diagram showing a first configuration of the mobile device.

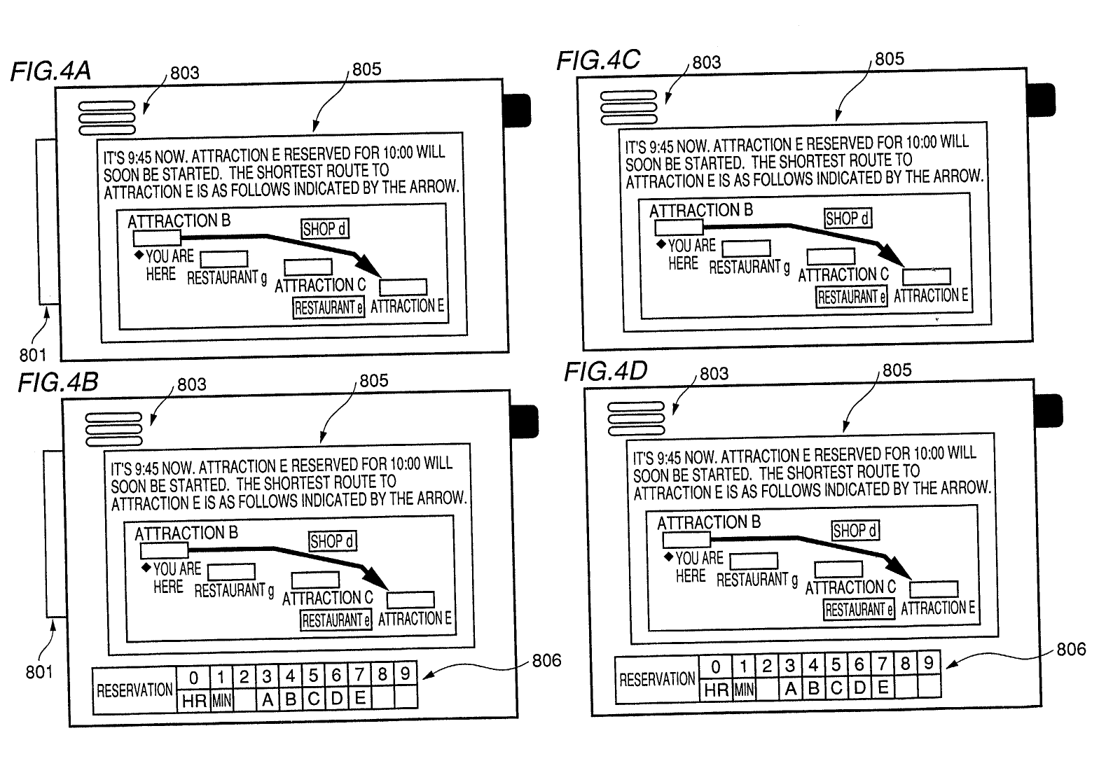

As shown in FIG. 3A, mobile device 80 includes a connection 801 to be connected to facility terminal 40, a wireless transceiver 802 communicating information with relay station 60, an audio output unit 803 notifying a visitor of his/her reservation time, a storage 804 storing for example a password of a visitor, and a display 85 corresponding for example to an LCD. FIG. 4A shows an appearance of the mobile device including the FIG. 3A configuration.

FIG. 3B is a block diagram showing a second configuration of the mobile device.

As shown in FIG. 3B, mobile device 80 also includes an input unit 806. FIG. 4B shows an appearance of the mobile device including the FIG. 3B configuration.

Input unit 806 includes numerical keys “0” to “9”, time keys “hour” and “minute”, and attraction keys “A” to “E”. For example, if a visitor desires to attend attraction E at ten o'clock, the visitor connects mobile device 80 to any facility terminal 40 and uses the keys of input unit 806 to input “1”, “0”, “hour”, “0”, “0”, “minute”, and “E” to make a reservation. The input information is displayed on display 805.

Thus the visitor can make a reservation of an attraction through an input to mobile device 80.

Furthermore, the visitor can use mobile device 80 as a non-contact mobile device, free of connection to facility terminal 40.

FIG. 3C is a block diagram showing a third configuration of the mobile device.

As shown in FIG. 3C, as compared with FIG. 3A, connection 801 is replaced by a non-contact interface 807 as a component. FIG. 4C shows a mobile device having the FIG. 3C configuration.

This can eliminate the necessity of a visitor connecting mobile device 80 to facility terminal 40 via a physical line.

FIG. 3D is a block diagram showing a configuration of the mobile device as a non-contact mobile device with an input unit added thereto. FIG. 4D shows an appearance of the mobile device having the FIG. 3D configuration.

This can eliminate the necessity of a visitor connecting mobile device 80 to facility terminal 40 via a cable and also allows the visitor to use mobile device 80 to input information.

Hereinafter in describing the embodiments of the present invention a visitor carries with him/her mobile device 80 including input unit 806 as shown in FIGS. 3B and 3D for the sake of convenience.

2. Function of Facility Administration System

The facility administration system has four functions, i.e., a facility user identification function provided to assign an identification at an entrance gate to a visitor using mobile device 80, a reservation function provided to allow a visitor to make a reservation of attractions A-E in amusement park 1, a guide function allowing facility administration apparatus 10 to guide a visitor to his/her received attraction A-E, and an account function provided to allow a visitor to collectively pay off his/her accounts in amusement park 1. The four functions will now be described in detail.

2.1 Facility User Identification Function

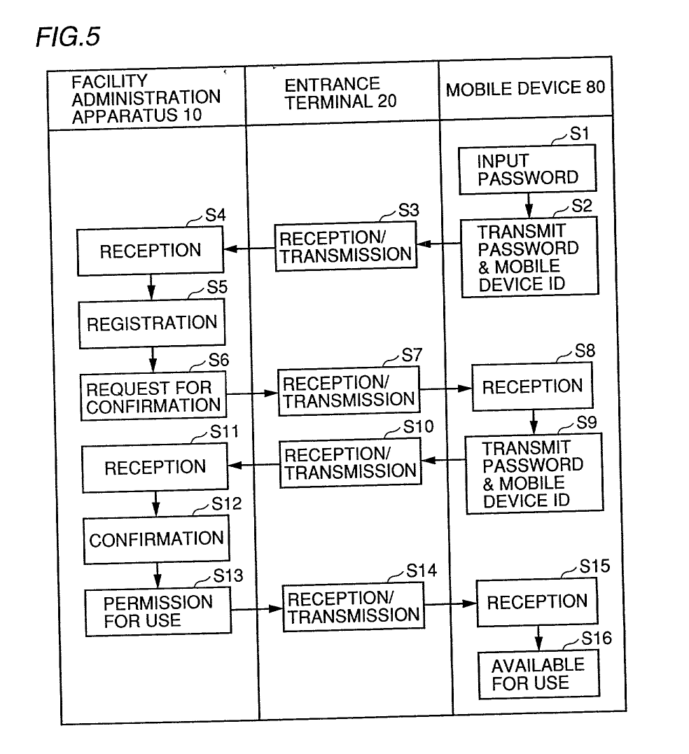

FIG. 5 is a flow chart representing an operation of the facility user identification function in an embodiment of the present invention.

With reference to FIG. 5, in amusement park 1 a visitor is initially supplied at an entrance gate of the park with mobile device 80 previously assigned a mobile device ID.

The visitor determines a password serving as an identifier of the visitor and inputs the password to mobile device 80 via input unit 806 (step S1). If mobile device 80 is such a direct-contact mobile device as shown in FIG. 3B, it is connected to entrance terminal 20 to input the password. If mobile device 80 is such a non-contact mobile device as shown in FIG. 3D, it is connected to entrance terminal 20 by wireless to input the password. The input password is transmitted to entrance terminal 20 together with the mobile device ID serving as the identifier of the mobile device (step S2). Entrance terminal 20 transmits the received password and mobile device ID to facility administration apparatus 10 via an internal, local area network (step S3).

Facility administration apparatus 10 receives the password and mobile device ID transmitted from entrance terminal 20 (step S4) and then registers them in hard disk 104 at master file 105. Master file 105 registers and stores the password and facility user ID in the form of a facility user management table, as shown in Table 1.

TABLE 1

| Mobile | | | |
|---|---|---|---|
| Device | | | Expiration Date & Time |
| ID No. | Password | Registration Time | of Password |
| 000001 | 1234 | January 1, 2000 at 09:10 | January 1, 2000 at 20:00 |
| 000002 | 5678 | January 1, 2000 at 09:15 | January 1, 2000 at 20:00 |
| 000003 | 9101 | January 1, 2000 at 09:18 | January 1, 2000 at 20:00 |
| 000004 | 1112 | January 1, 2000 at 09:20 | January 2, 2000 at 20:00 |
| . . . | . . . | . . . | . . . |
| . . . | . . . | . . . | . . . |

As shown in the Table 1 facility user administration table, in a column “Mobile Device ID. No.” is registered a mobile device ID corresponding to an identifier of mobile device 80 carried by a visitor, in a column “password” is registered a password determined by the visitor, in a column “Registration Time” is stored a date and time when facility administration apparatus 10 has registered the password, and in a column “Expiration Date & Time of Password” is recorded the expiration date and time of the password recorded in the Password column. For example, as shown in the Table, a visitor having a mobile device with an ID No. 0001 determines a password “1234”, which is registered on Jan. 1, 2000 at 9:10 and valid until Jan. 1, 2000 at 20:00. With the password valid only for a determined, limited period of time, if the visitor has lost mobile 80 device 80 and another person has acquired the lost mobile device 80 the person cannot exploit the device.

After facility administration apparatus 10 has registered the mobile device ID and the password in the facility user administration table, facility administration apparatus 10 requests retransmission of the mobile device ID and the password for verification (step S6). The request issued from the facility administration apparatus 10 to retransmit the mobile device ID and the password is received via entrance terminal 20 (step S7) by mobile device 80 (step S8).

Responsively, the visitor again inputs the password to mobile device 80 via input unit 806. Mobile device 80 retransmits the input password together with the mobile device ID via entrance terminal 20 (step S10) to facility administration apparatus 10 (step S9).

Facility administration apparatus 10 receives the mobile device ID and password retransmitted from mobile device 80 (step S11) and then at verifier 102 compares the mobile device ID and password retransmitted from mobile device 80 with the mobile device ID and password stored in master file 105 on the facility user administration table (step S12).

If the mobile device ID and password retransmitted from mobile device 80 match those stored in master file 105 on the facility user administration table, then facility administration apparatus 10 transmits a permission allowing the mobile device 80 to be used (step S13). The transmitted information permitting mobile device 80 to be used is received via entrance terminal 20 (step S14) by mobile device 80 (step S15). Thus the visitor is allowed to use mobile device 80 (step S16).

The visitor thus uses mobile device 80 having a mobile device ID assigned exclusively to mobile device 80 as well as a password determined by the user to serve as an identifier exclusive to the user. Thus whenever the visitor uses mobile device 80 the visitor is required to input his/her password.

As such, if the visitor has lost mobile device 80 and another person has acquired mobile device 80, the person cannot exploit mobile device 80 as the device requires the person to input the password. Furthermore, with the password having a period of validity imposed thereon, if another person having acquired mobile device 80 has also acquired the password of the visitor, the person cannot exploit mobile device 80 once the period of validity has expired.

This can prevent a third party from exploiting mobile device 80.

2.2 Reservation Function

Of the facility user administration system, the reservation function will now be described.

Initially a description will be made of the reservation function when the FIG. 3B direct-contact mobile device 80 is used.

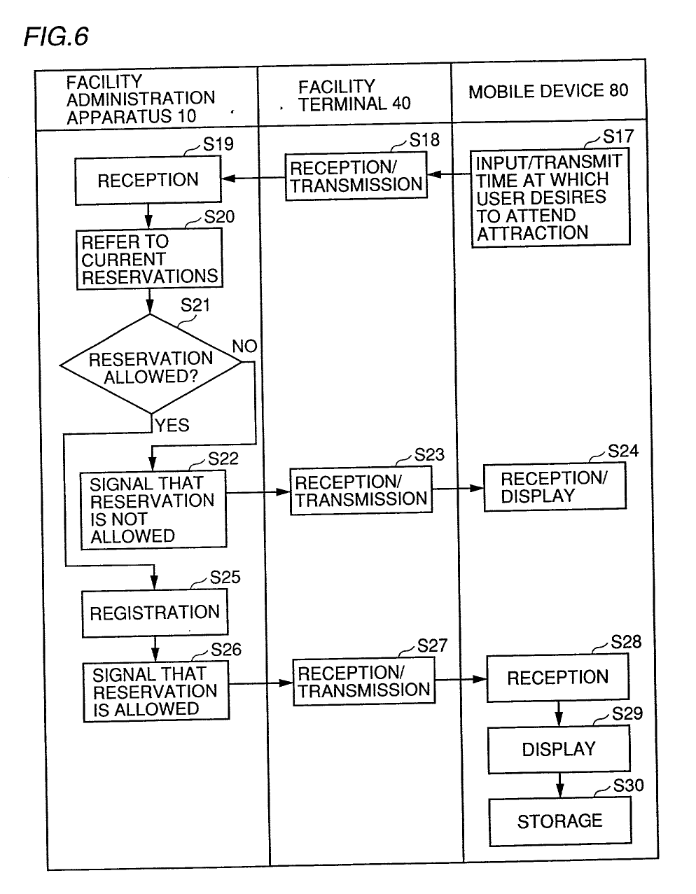

FIG. 6 is a flow chart representing an operation of a reservation function when a direct-contact mobile device 80 in an embodiment of the present invention is used.

With reference to FIG. 6, in amusement park 1 a visitor inputs to mobile device 80 via input unit 806 the name of any of attractions A-E of the park that the visitor desires to attend and the time at which the visitor desires to attend the attraction (step S17). To input the information, mobile device 80 is connected to facility terminal 40 installed at one of the facilities. The information input to mobile device 80 indicating the attraction that the visitor desires to attend and the time at which the visitor desires to attend the attraction, is transmitted via facility terminal 40 (step S18) and received by facility administration apparatus 10 (step S19).

Facility administration apparatus 10 records reservations of attractions A-E in hard disk 104 at master file 107 in the form of an attraction reservation table, as shown in Table 2 below:

TABLE 2

| Attraction | | |
|---|---|---|
| Facility | | |
| Reserved | Reservation Time | ID No. |
| . . . | . . . | . . . |
| E | January 1, 2000 at 10:00 | 000001 |
| E | January 1. 2000 at 10:00 | 000012 |
| E | January 1, 2000 at 10:00 | 000752 |
| Total | | 150 people |
| Available for: | | 50 more people |
| . . . | . . . | . . . |
| E | January 1, 2000 at 15:00 | 000321 |
| E | January 1, 2000 at 15:00 | 001254 |
| E | January 1, 2000 at 15:00 | 000011 |

| | |
|---|---|
| Total | 72 people |
| Available for: | 128 more people |

As shown on the attraction reservation table, in a column “Attraction Facility Reserved” is stored the name of a facility corresponding to an attraction that a visitor desires to attend, in a column “Time of Attendance” is stored that time at which the visitor desires to attend the attraction, and in a column “ID No.” is recorded the mobile device ID of mobile device 80 carried by a visitor desiring to make a reservation of an attraction. On the attraction reservation table, the number of mobile devices ID numbers are totaled for each attraction start time, from which result is calculated how many more people can still be accepted for the attraction start time, as shown in the column “Available for:”. For example, as shown on Table 2, on Jan. 1, 2000 at 10:00 o'clock attraction E, with a maximal capacity of 200 people at a time, is scheduled to be attended by a total of 150 visitors and is thus still available to 50 more people for reservation. Attraction E on Jan. 1, 2000 starting at 15:00 o'clock, with 72 mobile device IDs in total, is thus available to 128 more people for reservation.

Facility administration apparatus 10, having received from mobile device 80 the information of the name of an attraction desired and the time of attendance desired, refers to the attraction reservation table shown on Table 2 and at decision block 103 determines whether a reservation can be made accordingly (step S20). If facility administration apparatus 10 referring to the attraction reservation table has determined that the reservation cannot be made (step S21) then facility at administration device 10 signals that the visitor cannot make a reservation of the attraction for the attraction start time desired by the visitor (step S22). The notification transmitted from facility administration apparatus 10 indicating that the reservation cannot be made, is transmitted via facility terminal 40 (step S23), and received by mobile device 80, which at display 805 displays that the reservation cannot be made (step S24).

If facility administration apparatus 10 at decision block 103 determines that a reservation can be made (step S21) then it registers in master file 107 on the attraction reservation table the information of the attraction desired by the visitor and the time at which the visitor desires to attend the attraction (step S25). Facility administration apparatus 10 signals that the reservation has been registered (step S26). The transmitted notification indicating that the reservation has been made is transmitted via facility terminal 40 (step S27), and received by mobile device 80 (step S28), which at display 805 displays that the reservation has been completely made (step S29). The information that the reservation has been completely made is stored in mobile device 80 at storage 804 (step S30). Thus the visitor can confirm via display 805 an attraction that the visitor has made a reservation of and the time at which the visitor is scheduled to attend the attraction.

Thus the visitor no longer needs to wait standing in a queue to attend an attraction, as conventional. Thus the visitor can efficiently spend his/her time in amusement park 1.

Description will now be made of a reservation system when the FIG. 3D non-contact mobile device 80 is used.

If non-contact mobile device 80 is used in amusement park 1 to make a reservation of an attraction in the park, facility administration apparatus 10 and mobile device 80 operate, as described with reference to FIG. 6.

The FIG. 6 facility terminal 40 operation, however, is provided by relay station 60 and master station 70 if non-contact mobile device 80 is used. More specifically, in FIG. 6 at step S17 mobile device 80 transmits information, which is in turn transmitted via relay station 60 rather than facility terminal 40 and received by master station 70. Master station 70 transmits the received information to facility administration apparatus 10. Subsequently, facility administration apparatus 10 and mobile device 80 communicate with each other similarly via relay station 60 and master station 70, rather than facility terminal 40, to mutually transmit information.

Thus, if a visitor uses non-contact mobile device 80, the visitor no longer needs to connect the device to facility terminal 40, as is required when direct-contact mobile device 80 is used, and the visitor can transmit information via relay station 60 and thus make a reservation of an attraction wherever in amusement park 1 the visitor is.

2.3 Guide Function

A description will now be made of the guide function of the facility user administration system.

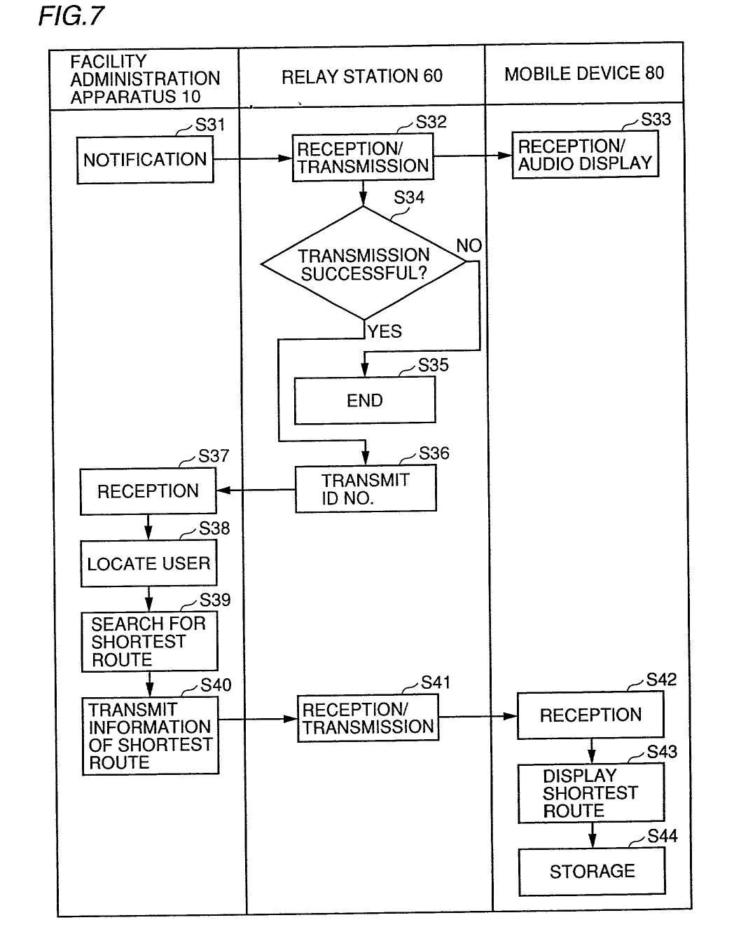

FIG. 7 is a flow chart representing an operation of a guide function in an embodiment of the present invention.

As shown in FIG. 7, if facility administration apparatus 10 at decision block 103 determines from the information recorded in master file 107 on the attraction reservation table that the start time of an attraction reserved by a visitor is approaching, e.g., the attraction will start in a predetermined temporal period for example of 15 minutes, then the facility administration apparatus 10 notifies the visitor of his/her reservation time, informing the visitor that the start time of his/her reserved attraction is approaching (step S31).

In signaling the notification, facility administration apparatus 10 at transceiver 101 transmits the notification to master station 70, and master station 70 at transmitter 702 transmits the notification in amusement park 1 to each relay station 60. Relay station 60 receives the notification transmitted from master station 70 indicating a reservation time and transmits the notification to mobile device 80 of the visitor (step S32). Mobile device 80, having received the notification of the reservation time, displays the same on display 805. Alternatively, audio output unit 803 audibly draws the attention of the visitor (step S33).

Then each relay station 60 determines as to whether the transmission to mobile device 80 has been successfully made (step S34). If not, relay station 60 terminates its operation (step S35).

Relay station 60 having successfully transmitted the notification to mobile device 80 each transmits to facility administration apparatus 10 the ID number of the relay station corresponding to an identifier assigned individually to the relay station (step S36). Facility administration apparatus 10 receives via master station 70 at receiver 701 the ID number of relay station 60 having successfully transmitted the notification to mobile device 80 (step S37).

Then, facility administration apparatus 10 at decision block 103 determines the position in amusement park 1 of the visitor carrying mobile device 80 with him/her (step S38).

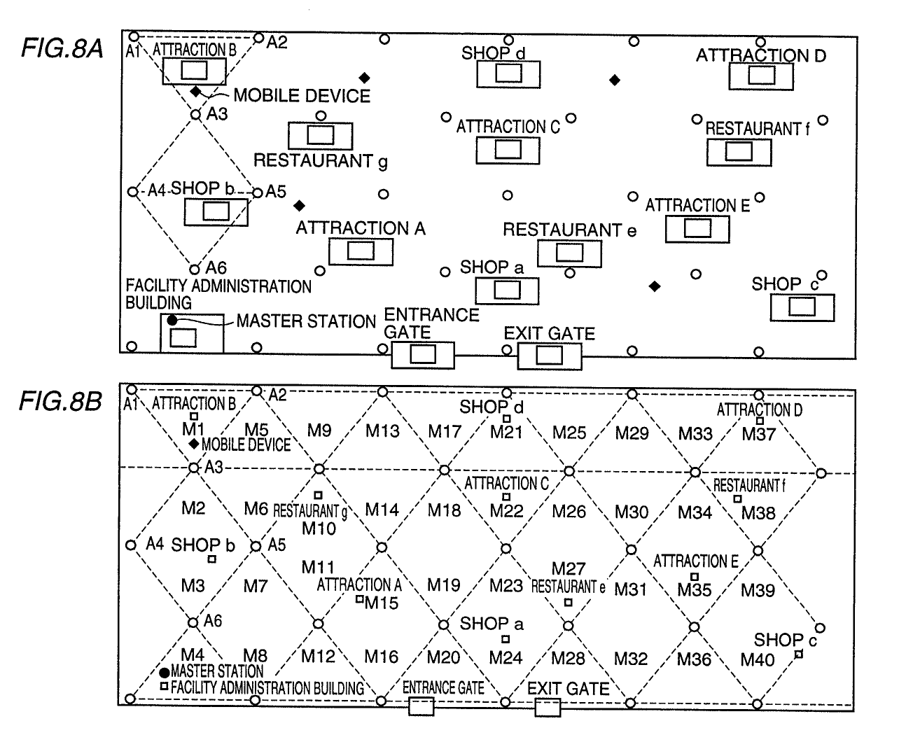

FIGS. 8A and 8B are schematic views illustrating a method of determining the position of a visitor in amusement park 1 carrying a mobile device with him/her.

With reference to FIG. 8A, if a visitor with mobile device 80 is in a vicinity of attraction B and facility administration apparatus 10 notifies the visitor of his/her reservation time, facility administration apparatus 10 transmits the notification of the reservation time via relay stations A1, A2 and A3 to mobile device 80. In amusement park 1, as shown in FIG. 8B, there are subareas numbered M1, M2, . . . each surrounded by three relay station 60. These subarea numbers are used to determine the position of a visitor carrying mobile device 80 with him/her.

Each subarea can receive information from relay stations 60 each corresponding to a vertex of the subarea and it cannot receive information from the other relay stations. As such, if the ID number of relay station 60 that has made a successful transmission to mobile device 80 can be found, the position of the visitor carrying mobile device 80 with him/her can also be determined.

The visitor near attraction B receives from relay stations A1, A2 and A3 the notification of his/her reservation time transmitted from facility administration apparatus 10. Thus, facility administration apparatus 10 receives the relay stations' identification numbers A1, A2 and A3. Thus facility administration apparatus 10 at decision unit 103 can determine that currently the visitor is located in subarea M1.

After the visitor's position is determined, facility administration apparatus 10 determines the shortest route from the visitor's position to the attraction that the visitor has made a reservation of (step S39).

Facility administration apparatus 10 determines the shortest route by referring to a shortest-route table, as shown in Table 3 below, stored in hard disk 104 at master file 108.

TABLE 3

| Attraction | | |
|---|---|---|
| Facility | Current | |
| Reserved | Position | Shortest Route |
| E | M1 | Attraction B → Restaurant g → Attraction C → Attraction E |
| E | M2 | . . . |
| E | M3 | . . . |
| E | M4 | . . . |
| E | M5 | . . . |
| E | M6 | . . . |

With reference to Table 3, as provided in the Shortest Route table, in a column “Attraction Facility Reserved” is recorded in the name of an attraction that a visitor is scheduled to attend, in a column “Current Position” is recorded the number of each subarea, and in a column “Shortest Route” is recorded the shortest route from a subarea recorded in the Current Position column to an attraction having it name stored in the Attraction Facility Reserved column.

For example, if the visitor in a vicinity of attraction B has a reservation of attraction E, facility administration apparatus 10 at decision block 103 searches the master file 105 Shortest Route table for a shortest route from attraction E to current position M1. If it has successfully retrieved a shortest route then it transmits the information of the shortest route (step S40).

The transmitted information of the shortest route is transmitted via relay station 60 (step S41) and thus received by mobile device 80 (step S42). Mobile device 80 displays the received information of the shortest route on display 805 (step S43). Mobile device 80 also stores the information of the shortest route to storage 804 (step S44).

Thus the visitor can be audibly notified that the start time of his/her reserved attraction is approaching. Furthermore, the visitor can also be notified of the shortest route from his/her current position to the attraction that the visitor desires to attend and the visitor can thus arrive at his/her desired attraction without being lost in the amusement park.

2.4 Account Function

An account function of the facility user administration system will now be described.

In amusement park 1 if a visitor attends attraction A-E, purchases items at shops a-d or enjoy services at restaurants e-g, the visitor must pay the fees for the attractions, the prices for the items or the charges for the services. It is significantly cumbersome, however, for the visitor to make payment at each facility.

The account function can eliminate the necessity of a visitor making payment at each facility and instead allows the visitor to collectively render payment at an exit gate of amusement park 1 when the visitor leaves the park.

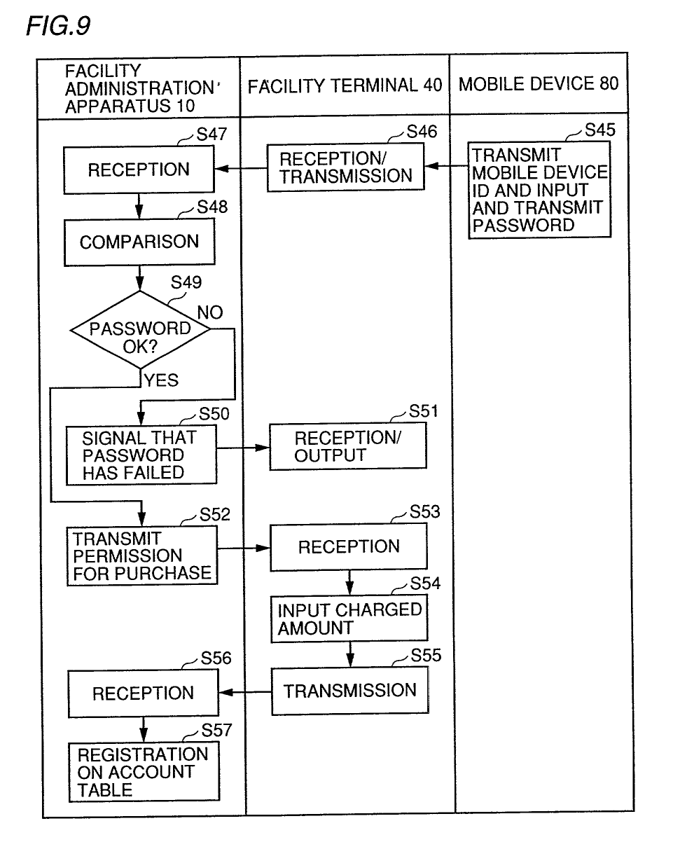

FIG. 9 is a flow chart representing an operation of one of account functions in one embodiment of the present invention when a visitor attends an attraction, purchases an item at a shop or enjoys services at a restaurant.

With reference to FIG. 9, a visitor for example having enjoyed services at a facility connects mobile device 80 by wireless or via a cable to facility terminal 40 arranged at the facility. Then the visitor inputs the visitor's password to mobile device 80 via input unit 806. Mobile device 80 transmits the input password together with a mobile device ID corresponding to the identifier of mobile device 80 (step S45). The mobile device ID and password transmitted from mobile device 80 are transmitted via facility terminal 40 (step S46) and received by facility administration apparatus 10 (step S47). Facility administration apparatus 10 at verifier 102 compares the received mobile device ID and password with those stored in master file 105 on the facility user administration table (step S408).

If the password fails to match any of the stored passwords (step S49) then facility administration apparatus 10 signals to facility terminal 40 accordingly (step S50). Facility terminal 40 notified that the password has failed displays the information on its display (not shown) (step S51) to allow an employee of amusement park 1 to notify the visitor that with the password the services cannot be charged on the visitor's account.

By contrast, if the transmitted password matches any of the stored passwords (step S49) then facility administration apparatus 10 transmits to facility terminal 40 a permission for purchase (step S52). Facility terminal 40 receives the permission for purchase (step S53) and an employee of the park then inputs to facility terminal 40 the value of the payment to be rendered by the visitor for example having enjoyed services (step S54). Facility terminal 40 transmits to facility administration apparatus 10 the information of the payment to be rendered that has been input to facility terminal 40 (step S55). The transmitted information on the payment to be rendered is received by facility administration apparatus 10 (step S56) and stored to hard disk 104 in master file 106. Such received information on payment to be rendered is recorded on an account information table, created as shown in Table 4.

TABLE 4

| Mobile | | | Name of | Changed | Payment |
|---|---|---|---|---|---|
| Device ID | Password | Time of Purchase | Facility | Item | to be Rendered |
| 000001 | 11234 | January 1, 2000 at 10:20 | shop a | Cookie × 1 | 1,000 |
| | | January 1. 2000 at 12:11 | restaurant e | Spaghetti × 1 | 1,200 |
| | | . . . | . . . | . . . | . . . |
| | | . . . | . . . | . . . | . . . |
| | | . . . | . . . | . . . | . . . |
| | | . . . | . . . | . . . | . . . |
| | | . . . | . . . | . . . | . . . |

| | |
|---|---|
| Total | 15,300 |

With reference to Table 4, the account information table includes a column “Mobile Device ID” receiving a mobile device ID serving as an identifier of a mobile device, a column “Password” receiving the password of a visitor, a column “Time of Purchase” recording the time at which a visitor used a facility, purchased an item or enjoyed services, a column “Name of Facility” recording the name of a facility at which a visitor has for example enjoyed services, a column “Charged Items” recording services, items and the like enjoyed by a visitor, and a column “Payment to be Rendered” recording the payment to be rendered by a visitor.

Facility administration apparatus 10 creates the account table as shown in Table 4 for each visitor and stores the table in master file 106.

A description will now be provided of an operation allowing a visitor of amusement park 1 to render payment when the visitor leaves the park.

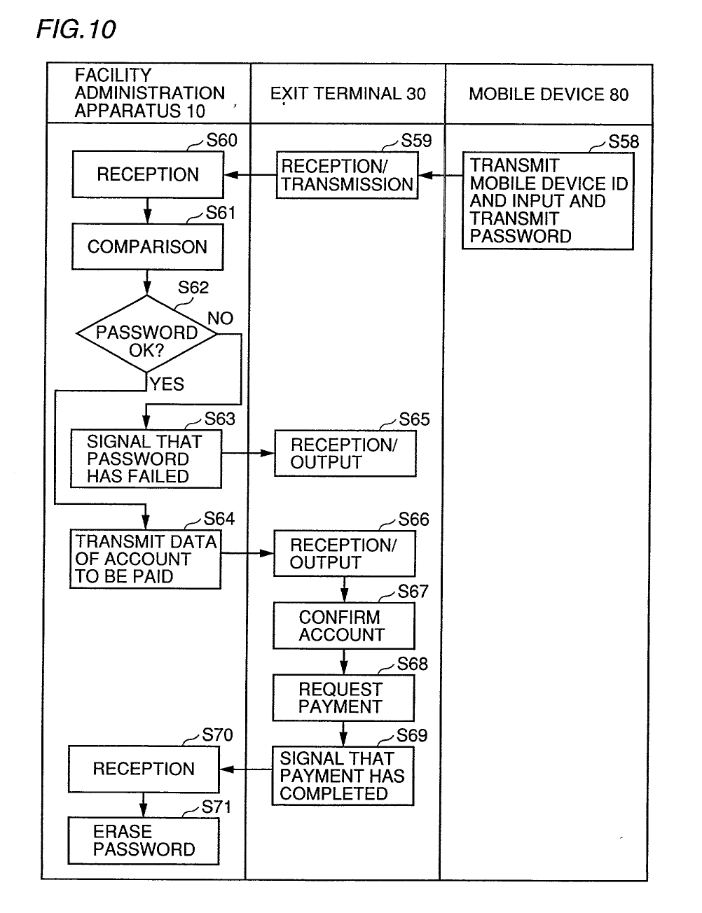

FIG. 10 is a flow chart representing an operation of one of account functions in an embodiment of the present invention that is provided at an exit gate.

With reference to FIG. 10, in amusement park 1 at an exit gate a visitor connects mobile device 80 to exit terminal 30 via a physical line or by wireless and then inputs the visitor's password to mobile device 80. Mobile device 80 transmits the input password together with its mobile device ID to exit terminal 30 (step S58). Exit terminal 30 receives the transmitted visitor's password and mobile device ID and transmits them (step S59) for reception by facility administration apparatus (step S60).

Facility administration apparatus 10 at verifier 102 verifies the mobile device ID and password received from mobile device 80 (step S61). If the mobile device ID and password received from mobile device 80 fail to match any of the mobile device IDs and passwords stored in master file 105 (step S62) then facility administration apparatus 10 signals to exit terminal 30 accordingly (step S63). Exit terminal 30 then displays on its display (not shown) the information that the transmitted password has failed (step S65).

In contrast, if facility administration apparatus 10 at verifier 102 verifies that the mobile device ID and password received from mobile device 80 match a mobile device ID and password stored in master file 105 (step S62) then facility administration apparatus 10 transmits to exit terminal 30 the Table 4 account information table as data of accounts to be liquidated by the visitor having used facilities and the like in amusement park 1 (step S64). Exit terminal 30 receives the account information table transmitted from facility administration apparatus 10 and have its display displaying the data of the table (step S66). The visitor checks the data of the account information table output on the display of exit terminal 30 (step S67). If the visitor agrees to the data of the account information table, exit terminal 30 requests the visitor to pay the account (step S68). When the visitor has completed his/her payment for the account, exit terminal 30 signal to facility administration apparatus 10 accordingly (step S69).

When facility administration apparatus 10 is signaled to from exit terminal 30 that the visitor has completed the payment for his/her account (step S70) facility administration apparatus 10 erases the visitor's password from master file 105 (step S71).

Thus a visitor visiting amusement park 1 can collectively pay the fees for facilities used by the visitor, the prices for items purchased at shops by the visitor and services enjoyed at restaurants by the visitor, at an exit gate of the park when the visitor leaves the park, no longer required to make payment cumbersomely whenever the visitor uses a facility, purchases an item at a shop or enjoys services at a restaurant.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A facility administration apparatus arranged in an area having a plurality of facilities collected therein, capable of communicating with a mobile device lent to a facility user via a plurality of relay stations each having a transceiver, and organizing a reservation of each facility as reservation information in response to a request transmitted from said mobile device for a reservation of each facility, comprising:
a reservation information master file storing said reservation information for each facility an identifier of said mobile device carried by said facility user having made a reservation, information of a facility reserved by said facility user, and a time at which said facility user desires to use said facility;
means for referring to said time in said reservation information master file to transmit via said relay station to said mobile device of said facility user a predetermined temporal period before said time a notification indicating that said time is approaching;
means for receiving an identifier of said relay station having transmitted said notification to said mobile device, and determining from said identifier of said relay station a position of said facility user carrying said mobile device with said user;
a shortest-route master file previously storing a shortest route from each subarea of said area to each facility;
means for determining a shortest route based on said position determined of said facility user, said information stored in said facility reservation master file indicating said facility reserved by said facility user, and said shortest-route master file; and
means for transmitting information of said shortest route.

2. The facility administration apparatus according to claim 1, wherein said means for receiving determines as a subarea having said facility user located therein a range surrounded by a plurality of said relay stations having transmitted said notification to said mobile device.

3. A facility administration apparatus arranged in an area having a plurality of facilities collected therein, and connectable via a network to a facility terminal arrangea at each facility connectable to a mobile device, comprising:
an identifier master file storing an identifier of a mobile device available;
means for comparing an identifier of a mobile device transmitted from said mobile device via said facility terminal with said identifier of said mobile device stored in said identifier master file;
means for receiving account information from said facility terminal if said identifier of said mobile device transmitted from said mobile device matches said identifier of said mobile device stored in said identifier master file; and
an account information master file storing said account information for said identifier of each said mobile device.

4. The facility administration apparatus according to claim 3, wherein:
said identifier master file further stores an identifier of said facility user carrying said mobile device with said user;
said means for comparing compares said identifier of said mobile device and said identifier of said facility user together transmitted from said mobile device via said facility terminal with said identifier of said mobile device and said identifier of said facility user together stored in said identifier master file; and
if said identifier of said mobile device and said identifier of said facility user together transmitted from said mobile device match said identifier of said mobile device and said identifier of said facility user together stored in said identifier master file, said facility administration apparatus receives account information transmitted from said facility terminal.

5. The facility administration apparatus according to claim 4, wherein said identifier master file further imposes a period of validity on said identifier of said facility user carrying said mobile device with said user.

6. A facility administration method employing a facility administration apparatus arranged in an area having a plurality of facilities collected therein, capable of communicating with a mobile device lent to a facility user via a plurality of relay stations each having a transceiver, and organizing a reservation of each facility as reservation information in response to a request transmitted from said mobile device for a reservation of each facility, comprising the steps of:
storing as said reservation information for each facility an identifier of said mobile device carried by said facility user having made a reservation, information of said facility reserved by said facility user, and a time at which said facility user desires to use said facility;
referring to said time in said reservation information master file to transmit via said relay station to said mobile device of said facility user a predetermined temporal period before said time a notification indicating that said time is approaching;
receiving an identification of said relay station having transmitted said notification to said mobile device, and determining from said identifier of said relay station a position of said facility user carrying said mobile device with said user;
previously storing in a shortest-route master file a shortest route from each subarea of said area to each facility;
determining a shortest route based on said position determined of said facility user, said information stored in said facility reservation master file indicating said facility reserved by said facility user, and said shortest-route master file; and
transmitting information of said shortest route.

7. The facility administration method according to claim 6, wherein said step of reserving and determining determines as a subarea having said facility user located therein a range surrounded by a plurality of said relay stations having transmitted said notification to said mobile device.

8. A facility administration method employing a facility administration apparatus arranged in an area having a plurality of facilities collected therein, and connectable via a network to a facility terminal arranged at each facility connectable to a mobile device, comprising the steps of:
storing in an identifier master file an identifier of said mobile device available;
comparing an identifier of a mobile device transmitted from said mobile device via said facility terminal with said identifier of said mobile device stored in said identifier master file;
receiving account information from said facility terminal if said identifier of said mobile device transmitted from said mobile device matches said identifier of said mobile device stored in said identifier master file; and
storing said account information to an account information master file for said identifier of each said mobile device.

9. The facility administration method according to claim 8, wherein:
said step of storing in said identifier master file also stores an identifier of said facility user carrying said mobile device with said user;
said step of comparing includes comparing said identifier of said mobile device and said identifier of said facility user together transmitted from said mobile device via said facility terminal with said identifier of said mobile device and said identifier of said facility user together stored in said identifier master file; and
account information is received from said facility terminal if said identifier of said mobile device and said identifier of said facility user together transmitted from said mobile device match said identifier of said mobile device and said identifier of said facility user together stored in said identifier master file.

10. The facility administration method according to claim 9, wherein said step of storing in said identifier master file imposes a period of validity on said identifier of said facility user carrying said mobile device with said user.
